(19) United States
(12) Patent Application Publication
(10) Pub. No.: US 2011/0041992 A1
(43) Pub. Date: Feb. 24, 2011

(54) ROLLS FOR ROLL FED LABELLING OF TEXTILE PRODUCTS

(75) Inventor: Johan Marcel Sijmons, Amstelveen (NL)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: POLYGRAPHIC HOLDING B.V., NIEUWEGEIN (NL)

(21) Appl. No.: 12/158,573

(22) PCT Filed: Dec. 20, 2006
(86) PCT No.: PCT/EP2006/070019

§ 371 Date: Oct. 12, 2009

(30) Foreign Application Priority Data
Dec. 22, 2005 (EP) 05112718.1

(51) Int. Cl. G09F 3/02; B65C 9/18; B65H 81/00; B32B 37/02

(52) U.S. Cl. 156/249; 40/299.01; 156/184; 156/73.4

(57) ABSTRACT

The present invention discloses a roll comprises a plurality of ribbons, each ribbon comprising a series of labels attached to a transparent support, whereby each ribbon is connected to an adjacent ribbon by means of a seal. The present invention further discloses a method for manufacturing such rolls.

The present invention relates to roll fed labelling of a product of choice, e.g. a textile product, and rolls suitable for use therein.

It is customary for manufacturers of textile products like garments and other finished fabrics (e.g., towels, bed linens, tablecloths, etc.) to attach thereto one or more labels that display various items of information, such as article size, fiber content, instructions for care, and the manufacturer's name or trademark. Such labels, which are to be contrasted with hanging price tags and the like, are typically not intended to be removed by the consumer after the purchase of the article, but rather, are intended to be permanently affixed to the article. In fact, such labels are commonly known in the industry as permanent care labels.

Such labels may typically be applied to the textile product by automatic, roll fed labelling. For roll fed labelling of a large number of textile products, large rolls comprising a ribbon comprising a plurality of labels attached to a support are used. Such rolls typically may contain an average of 5000 labels per roll.

These large label rolls can conveniently be prepared by printing the desired label onto a suitable support ribbon directly on the roll that is later used for roll fed labelling. Direct label printing on the roll is advantageous, since the label-containing ribbon is continuous.

In order to possess freedom to use any amount of label, also relatively small amounts, it is desirable to use rolls containing a ribbon with a small amount of labels, typically not exceeding an amount of about 1000 labels per roll. However, direct printing of labels onto a support ribbon on a roll is only feasible with very large rolls. For smaller rolls, direct printing on the roll is not cost-effective.

Rolls for roll fed labelling of textile products are known whereby the label is attached to paper support material and series of label-containing ribbons are connected to each other by an adhesive tape

However, paper has the disadvantage that it necessitates the use of marks for correct positioning of the label on the textile. In addition, the tensile strength of the ribbon is low.

Thus, in a first aspect, the present invention provides a roll for roll fed labelling of e.g. textile products, that provides freedom to choose any amount of label for subsequent labelling and that does not possess the above disadvantages of a roll comprising paper ribbons.

The roll comprises a plurality of ribbons, each ribbon comprising a series of labels attached to a transparent support, whereby each ribbon is connected to an adjacent ribbon by means of a seal.

The transparent support may be any transparent material (foil) that is suitable to function as a label support. For instance, the transparent material may be a plastic foil, e.g. polyester.

The seal connecting adjacent ribbons may be any seal that is suitable to connect two adjacent ribbons of transparent support material and that provides an appropriate tensile strength to the connected ribbons such that the ribbon has the capability to resist the tractive force that is applied, in particular during automatic roll fed labelling. Preferably, the seal is applied by high frequency or ultrasonic sealing. However, it is also possible to use a suitable adhesive.

In a second aspect, the present invention provides a method for manufacturing the rolls of the first aspect.

In particular, the present invention provides a method for the manufacturing of a roll for roll fed labelling of e.g. textile products comprising the steps of:

a) applying labels of choice onto a sheet of transparent support material in a suitable amount of rows, the width of a row corresponding to the width of the roll, whereby each row comprises a series of labels for consecutive labelling,

b) cutting the sheets into ribbons of a width corresponding to the width of the row as well as the width of the roll,

c) sealing the ribbons on their smallest edge to obtain a plurality of sealed ribbons,

d) applying the plurality of sealed ribbons to a roll.

Prior to applying the labels of choice onto the sheet of transparent support material, a release coating typically may be applied to the transparent material. This release coating enables release of the label from the support material in the product labelling step. After application of the labels onto the sheet, an adhesive may be applied to enable attachment of the label to the product to be labelled.

The sealing of the ribbons preferably is done by high frequency or ultrasonic sealing.

The size of the sheets that are used for applying the labels conveniently is determined by ease of handling principles. Too large sheets, e.g. sheets with a length and/or width exceeding 150-200 cm will become cumbersome to handle.

In a further aspect, the present invention relates to the use of the rolls of the previous aspect for labelling of a product of choice. The rolls according to the invention may be used in any roll fed labelling method known in the art. The rolls are suitable for use in labelling machines due to the appropriate tensile strength of the ribbon. A product of choice may be a textile product, e.g. underwear, shirts, skirts, a leather product, e.g. shoes, a canvas product, e.g. bags.

1. A roll for roll fed labelling of a product of choice, the roll comprising a plurality of ribbons, each ribbon comprising a series of labels attached to a transparent support, whereby each ribbon is connected to an adjacent ribbon by means of a seal.

2. The roll of claim 1, wherein the seal is a high frequency or ultrasonically applied seal.

3. A method for the manufacturing of the roll of claim 1 comprising the steps of:
a) applying a desired label onto a sheet of transparent support material in a suitable amount of rows, the width of a row corresponding to the width of the roll, whereby each row comprises a series of labels for consecutive labelling,
b) cutting the sheets into ribbons of a width corresponding to the width of the row as well as the width of the roll,
c) sealing the ribbons on their smallest edge to obtain a plurality of sealed ribbons,
d) applying the plurality of sealed ribbons to a roll.

4. The method according to claim 3 wherein sealing of the ribbons is done by high frequency or ultrasonic sealing.

5. A method of labelling a product comprising the step of labelling a product with a roll according to claim 1.

6. A method for the manufacturing of the roll of claim 2 comprising the steps of:
a) applying a desired label onto a sheet of transparent support material in a suitable amount of rows, the width of a row corresponding to the width of the roll, whereby each row comprises a series of labels for consecutive labelling,
b) cutting the sheets into ribbons of a width corresponding to the width of the row as well as the width of the roll,
c) sealing the ribbons on their smallest edge to obtain a plurality of sealed ribbons,
d) applying the plurality of sealed ribbons to a roll.

7. The method according to claim 6 wherein sealing of the ribbons is done by high frequency or ultrasonic sealing.
